(19) United States
(12) Patent Application Publication
(10) Pub. No.: US 2026/0267661 A1
(43) Pub. Date: Sep. 10, 2026

(54) ELECTRONIC APPARATUS AND CONTROL METHOD

(71) Applicant: Lenovo Japan LLC, Tokyo (JP)

(72) Inventors: Yusaku Morishige, Kanagawa (JP); Ken Sasaki, Kanagawa (JP); Naoyuki Araki, Kanagawa (JP); Kazuya Shibayama, Kanagawa (JP)

(73) Assignee: Lenovo Japan LLC, Tokyo (JP)

(21) Appl. No.: 19/456,392

(22) Filed: Jan. 22, 2026

(30) Foreign Application Priority Data
Mar. 6, 2025 (JP) 2025-035174

(51) Int. Cl. G06F 9/4401

(52) U.S. Cl. CPC G06F 9/4416

(57) ABSTRACT

An electronic apparatus includes a host system. The host system executes initialization processing in accordance with firmware before startup of an operating system. The initialization processing has a selectable function, the selectable function being a function which whether or not to execute is selectable. Each time the initialization processing is executed, the host system determines disablement of the selectable function based on an unused consecutive count, the unused consecutive count being a number of times the selectable function is not executed consecutively.

### CROSS-REFERENCE TO RELATED APPLICATIONS

This application claims priority to Japanese Patent Application No. 2025-035174 filed on Mar. 6, 2025, the contents of which are hereby incorporated herein by reference in their entirety.

### TECHNICAL FIELD

The present application relates to an electronic apparatus and a control method, for example, regarding initialization of a host system.

### BACKGROUND

An electronic apparatus such as a personal computer (PC) usually initializes a host system and peripheral devices based on a basic input output system (BIOS) at the time of startup. During the initialization, a diagnostic test referred to as power on self-test (POST) processing is executed.

For example, an information processing apparatus described in Japanese Unexamined Patent Application Publication No. 2024-001936 executes the POST processing for each module indicating a partial function of BIOS according to settings of BIOS, measures a POST time for each module, determines whether or not the POST time is increased based on a reference value of the POST time of the module, and specifies an abnormal module in which an abnormality has occurred.

In recent years, a required time (POST time) of the POST processing tends to increase. A cause for this is that a wide variety of functions are being added to electronic apparatuses as needed. Along with the addition of functions, initialization processing and binding processing are required for each of a driver (for example, a unified extensible firmware interface driver (UEFI)) for realizing the functions and a device for realizing the functions. The required time for the initialization processing and the binding processing is generally proportional to the number of combinations of the drivers and the devices.

In addition, in general, the BIOS is stored in a storage medium such as a serial peripheral interface (SPI) flash memory and is read out in the POST processing. In order to ensure resiliency of a host system, verification may be performed on a BIOS region in which the BIOS is stored. In the verification, for example, an encryption method such as an elliptic curve digital signature algorithm (ECDSA) is used. The verification and decryption of the encrypted BIOS also become factors that increase the required time.

### SUMMARY

An electronic apparatus according to an aspect of the present application includes a host system, in which the host system executes initialization processing in accordance with firmware before startup of an operating system, the initialization processing has a selectable function, the selectable function being a function which whether or not to execute is selectable, and each time the initialization processing is executed, the host system determines disablement of the selectable function based on an unused consecutive count, the unused consecutive count being a number of times the selectable function is not executed consecutively.

In the electronic apparatus, the host system may cause a display to display a notification screen representing the disablement when the host system disables the selectable function.

In the electronic apparatus, the notification screen may represent an operation method for releasing the disablement.

In the electronic apparatus, the host system may decrease an invalid expectation count as a difference between the unused consecutive count and the invalid expectation count increases, the invalid expectation count being a reference value for determining the disablement by comparison with the unused consecutive count.

The electronic apparatus may further include a storage medium including a plurality of storage regions, each of the plurality of storage regions where an encrypted driver is stored, in which the host system may specify a storage region in which a driver corresponding to a function that is not executed is stored and a driver corresponding to a function that is executed is not stored, and omit decryption of the driver stored in the storage region.

In the electronic apparatus, the selectable function may relate to startup of an operating system instructed from another apparatus.

A control method according to another aspect of the present application is a control method for an electronic apparatus including a host system, in which the host system executes initialization processing in accordance with firmware before startup of an operating system, the initialization processing has a selectable function, the selectable function being a function which whether or not to execute is selectable, and each time the initialization processing is executed, the host system determines disablement of the selectable function based on an unused consecutive count, the unused consecutive count being the number of times the selectable function is not executed consecutively.

The above-described embodiments of the present application can reduce a required time for initialization processing while ensuring necessary functions.

### BRIEF DESCRIPTION OF THE DRAWINGS

FIG. 1 is a schematic block diagram illustrating an example of a hardware configuration of an electronic apparatus according to one or more embodiments.

FIG. 2 is a schematic block diagram illustrating an example of a functional configuration of the electronic apparatus according to one or more embodiments.

FIG. 3 is a table illustrating UEFI drivers corresponding to boot options according to one or more embodiments.

FIG. 4 is a table illustrating unused consecutive counts and invalid expectation counts corresponding to boot options according to one or more embodiments.

FIG. 5 is a diagram illustrating a setting screen according to one or more embodiments.

FIG. 6 is a flowchart illustrating an example of preboot processing according to one or more embodiments.

FIG. 7 is a flowchart illustrating boot option setting processing according to one or more embodiments.

FIG. 8 is a flowchart illustrating invalid expectation count recalculation processing according to one or more embodiments.

FIG. 9 is an explanatory diagram illustrating omission of decryption of drivers stored in a ROM according to one or more embodiments.

### DETAILED DESCRIPTION OF THE INVENTION

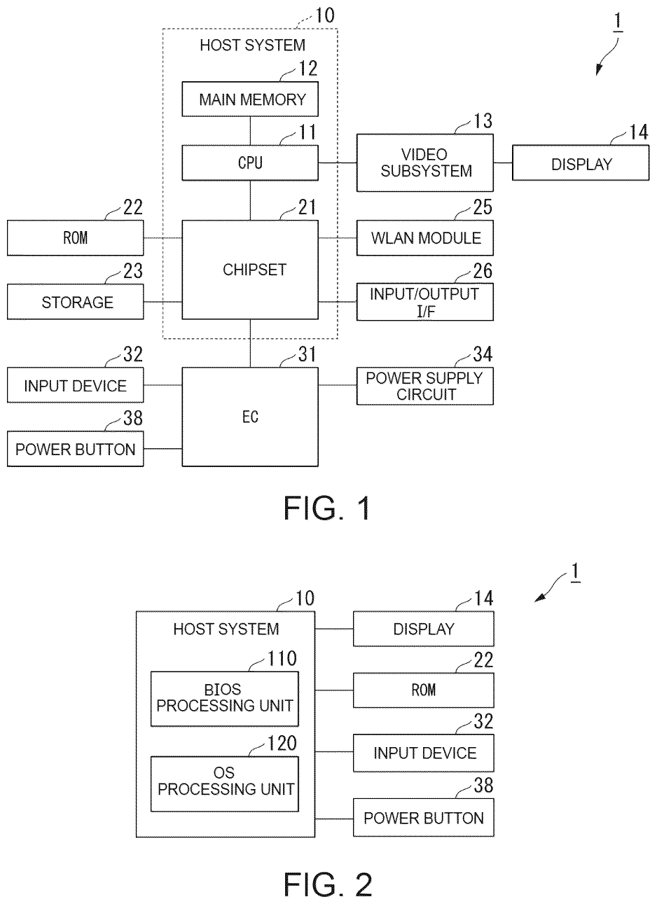

Hereinafter, embodiments of the present application will be described with reference to the drawings. A configuration example of an electronic apparatus 1 according to one or more embodiments will be described. FIG. 1 is a schematic block diagram illustrating an example of a hardware configuration of the electronic apparatus 1 according to one or more embodiments. In the example of FIG. 1, the electronic apparatus 1 is configured as a laptop PC (may be referred to as a “laptop PC” in the present application).

The electronic apparatus 1 includes a host system 10, a video subsystem 13, a display 14, a read-only memory (ROM) 22, a storage 23, a wireless local area network (WLAN) module 25, an input/output interface (I/F) 26, an EC 31, an input device 32, and a power supply circuit 34.

The host system 10 is a computer system that forms the core of the electronic apparatus 1. The host system 10 includes a central processing unit (CPU) 11, a main memory 12, and a chipset 21. In the present application, a device constituting the host system 10 may be referred to as a “host device”.

The CPU 11 is a processor that executes various programs. For example, programs such as firmware, an operating system (OS), utility software, and an application program are executed. In the present application, “executing a program” or “execution of a program” refers to executing processing instructed by commands described in the program. The CPU 11 executes various programs to implement the functions of the host system 10 in cooperation with the main memory 12 and other hardware.

The main memory 12 is a writable memory used as a read area for an execution program of the CPU 11 or as a work area for writing processing data of an execution program. The main memory 12 is configured with, for example, a plurality of dynamic random access memory (DRAM) chips. The CPU 11 and the main memory 12 are minimum hardware that constitute the host system 10.

The video subsystem 13 is a subsystem for implementing a function related to image display. The video subsystem 13 includes a video controller and a video memory (not illustrated). The video controller generates drawing information in response to a drawing command input from the CPU 11 and writes the generated drawing information to the video memory. The video memory temporarily stores the drawing information generated by the video controller. The video controller reads out the stored drawing information in the video memory at a predetermined cycle, and outputs display data representing a display screen composed of the read drawing information to the display 14.

The display 14 displays a display screen based on display data input from the video subsystem 13. The display 14 may be, for example, any of a liquid crystal display (LCD), an organic light emitting diode (OLED) display, and the like.

The chipset 21 includes a plurality of controllers and is connectable to a plurality of devices so that various types of data is input and output. The controller provided in the chipset 21 may be, for example, any of a universal serial bus (USB), a serial peripheral interface (SPI) bus, a PCI-Express bus, and the like. In the example of FIG. 1, the chipset 21 is connected to the ROM 22, the storage 23, the WLAN module 25, the input/output I/F 26, and the EC 31.

The ROM 22 mainly stores firmware. The firmware stored in the ROM 22 includes system firmware such as a basic input/output system (BIOS) and firmware for controlling individual devices, and the like. In addition, the firmware usually includes a plurality of driver software programs (which may be simply referred to as “drivers” in the present application). In the present application, the BIOS refers to system firmware for instructing operation of the host device and starting up the OS, and mainly means a system BIOS (that is, a UEFI BIOS) in which a unified extensible firmware interface (UEFI) is adopted, and may include a UEFI driver. The ROM 22 may be any of an electrically erasable programmable read-only memory (EEPROM), a flash ROM, and the like.

The storage 23 is an auxiliary storage device that non-transitorily stores, in a readable and writable manner, various types of data used for processing of the host system 10, various types of data obtained by the processing, various programs, or the like. The storage 23 may be, for example, any of a solid-state drive (SSD), a hard-disk drive (HDD), and the like.

The WLAN module 25 is connected to WLAN to transmit and receive various types of data. The WLAN module 25 is capable of transmitting and receiving various types of data to and from other devices connected to the WLAN or to another network via the WLAN. The other networks may be, for example, any of the Internet, a public wireless network, a virtual dedicated network, and the like.

The input/output I/F 26 is connected to various devices by wired or wireless communication to enable input and output of data. The input/output I/F 26 includes, for example, a USB connector. The USB connector is a connector for inputting and outputting data by wire in accordance with USB standards.

The embedded controller (EC) 31 is a controller that monitors and controls the operation of various devices connected to the EC 31, regardless of the operating state of the host system 10. The EC 31 includes a CPU, a ROM, a RAM, a timer, and an input/output I/F separately from the host system 10. A device with a data transfer rate lower than that of the chipset 21 may be connected to EC 31. In the example of FIG. 1, the input device 32, the power supply circuit 34, and a power button 38 are connected to the EC 31.

The input device 32 detects the operation of a user, generates an operation signal in response to the detected operation, and outputs the generated operation signal to the EC 31. The input device 32 may be, for example, any one of a keyboard, a touch sensor, a track point, or the like, or may be any combination thereof.

The power supply circuit 34 executes supply of power to each device under the control of the EC 31. The power supply circuit 34 includes a charger and a transformer (direct current/direct current (DC/DC)).

The charger charges the battery with surplus power of the power supplied from the external power supply that remains without being consumed by each device. When power is not supplied from the external power supply or when the power supplied from the power supply does not satisfy the demand of each device, the charger supplies the power discharged from the battery to each device via the transformer.

The transformer converts a voltage of DC power supplied from the external power supply or the battery via the charger into a voltage required for the operation of each device. The transformer supplies, to a destination device, DC power having the converted voltage.

The power button 38 receives a pressing operation, and each time the pressing operation is received, notifies the EC 31 of power on and power off of the electronic apparatus 1. When the pressing operation is received, the power button 38 outputs a pressing signal indicating the pressing to the EC 31. When the pressing signal is input from the power button 38 while a state of the electronic apparatus 1 is power off, the EC 31 causes the power supply circuit 34 to start supplying power to each device of the electronic apparatus 1 (power on).

On the other hand, when power is supplied to the electronic apparatus 1 and a pressing signal is input from the power button 38, the EC 31 causes the CPU 11 to execute stop processing (shutdown). In the stop processing, the CPU 11 saves the data present in the work area at that time in the storage 23. After completing the saving of the data, the CPU 11 stops the processing by the application, the device driver, and other programs that are being executed at that time. Thereafter, the CPU 11 notifies the EC 31 of the completion of the stop processing. The EC 31 causes the power supply circuit 34 to stop the supply of power to each device of the electronic apparatus 1.

Next, an example of a functional configuration of the electronic apparatus 1 according to one or more embodiments will be described. FIG. 2 is a schematic block diagram illustrating an example of a functional configuration of the electronic apparatus 1 according to one or more embodiments.

The host system 10 includes a BIOS processing unit 110 and an OS processing unit 120.

Functions of the BIOS processing unit 110 are implemented by the CPU 11 executing the BIOS. The BIOS processing unit 110 executes preboot processing. The preboot processing constitutes part of startup processing and corresponds to initialization processing until the start of the OS startup (OS boot). The preboot processing includes power on self-test (POST) processing. In the present application, the startup processing refers to a series of processes until the entire electronic apparatus 1 is in a usable state so as to exhibit the expected function from power on. In addition, the boot mainly refers to processing related to the OS startup (OS boot), and the reboot mainly refers to processing related to restarting (reboot).

The CPU 11 detects power on when the supply of power from the power supply circuit 34 is started. In this case, the CPU 11 starts the startup processing. When the CPU 11 detects power on, the CPU 11 reads the BIOS from the ROM 22, executes the BIOS in accordance with the read BIOS, and exhibits the functions. The BIOS includes a plurality of drivers and is configured by layering these drivers. The plurality of drivers is distributed among and stored in a plurality of feature volumes (FVs). The plurality of FVs each constitute a part of the storage region of the ROM 22.

The BIOS processing unit 110 sequentially reads out the drivers stored in the ROM 22, loads the read drivers into the main memory 12, and sequentially executes processes instructed by the commands described in the drivers. The BIOS processing unit 110 executes basic device initialization, system setting, and POST processing. The basic device initialization includes processing such as detection and initialization of basic devices (for example, the CPU 11, the main memory 12, the video subsystem 13, the display 14, the chipset 21, the EC 31, and the input device 32). The system setting includes processing of setting operating parameters of the BIOS.

The POST processing includes processing such as consistency verification, device detection, authentication, and system management. The consistency verification includes processing such as determining integrity of the entire BIOS and repairing missing code. The device detection includes processing such as detection of peripheral devices connected to the basic device and initialization of the detected peripheral devices. Startup management includes processing of reading out a boot loader stored in the storage 23 in advance, loading the read boot loader into the main memory 12, and the like.

Some of the POST processing is not always essential, and there is a function (in the present application, may be referred to as “selectable functions”) in which whether or not to execute is selectable depending on the use environment of the electronic apparatus 1 or the preference of the user. The selectable functions also include those that are provided such that one option among a plurality of types of options is selected and the other types of options are not selected. The selectable functions are set, for example, at a stage of system setting. The selectable functions include boot options related to the boot processing. In the following description, a case where the selectable functions are applied to the boot option will be mainly described as an example.

The BIOS processing unit 110 displays, for example, a setting screen on the display 14 and sets whether or not to execute each boot option in response to the operation. Whether or not each boot option is executable may be set in advance (default setting). When there is no specific instruction regarding whether or not to execute, the default setting is applied. The timing at which the setting screen is displayed is, for example, a time when a predetermined operation (for example, pressing an F1 key of a keyboard) is received from immediately after power on to the start of the POST processing. The BIOS processing unit 110 controls, in the POST processing, whether or not to execute the driver related to the corresponding boot option in accordance with the setting. The installation of the driver related to the boot option that is determined to be not executed, that is, the reading from the ROM 22 and the loading into the main memory 12 may be omitted. The OS processing unit 120 may display a setting screen (for example, a boot option) related to the POST processing after OS startup when a predetermined user operation is received (for example, when an item of a detailed option is selected from a system setting menu). In that case, after the host system 10 is shut down, when the BIOS processing unit 110 resumes the POST processing, the BIOS processing unit 110 controls whether or not to execute the boot option in accordance with the settings.

The BIOS processing unit 110 may be set whether or not to execute the entire POST processing without allowing the omission (skipping) of the execution of part of the POST processing. In one or more embodiments, an execution mode in which the omission of the execution of part of the POST processing is allowed is referred to as a “skip ON mode”, and an execution mode in which the omission of the execution is not allowed is referred to as a “skip OFF mode”. Any one of the skip ON mode and the skip OFF mode may be selectable in response to the operation by displaying the setting screen as described above.

The BIOS processing unit 110 counts, for each boot option, the number of times that the boot option has not been executed consecutively as an unused consecutive count each time the POST processing is executed. For the boot option for which the POST processing is executed, the BIOS processing unit 110 sets the unused consecutive count to zero. The BIOS processing unit 110 enables a boot option whose unused consecutive count is equal to or less than a predetermined invalid expectation count, and makes whether the boot option is to be executed selectable. The BIOS processing unit 110 disables a boot option whose unused consecutive count exceeds the predetermined invalid expectation count, and omits (skips) execution of the boot option without allowing selection as to whether the boot option is to be executed. The BIOS processing unit 110 is able to omit reading the driver related to the disabled boot option and loading the driver into the main memory 12. The invalid expectation count corresponds to a reference value of the unused consecutive count used for determining a disabled state of the boot option. The invalid expectation count may be a predetermined constant value. The BIOS processing unit 110 may exclude display of a disabled boot option from the setting screen and may not receive the setting of whether the boot option is enabled or disabled.

When the disabled boot option is present, the BIOS processing unit 110 may include, in the setting screen, display of the presence of the disabled option or notification information indicating the disabled boot option, and may cause the display 14 to display the setting screen.

The BIOS processing unit 110 may further include, in the setting screen, the notification information and guide information for guiding an operation method for releasing disabling of a boot option and may cause the display 14 to display the setting screen.

The BIOS processing unit 110 enables the disabled boot option when the guided operation is detected. The BIOS processing unit 110 may restore the boot option display that is enabled on the setting screen. The BIOS processing unit 110 is capable of re-selecting whether or not to execute the enabled boot option in response to the operation.

The OS processing unit 120 executes the OS and related software to provide basic functions. The related software refers to software that cooperates with the OS. Examples of the related software include a device driver and a utility. The basic functions include memory management, task management, file management, input/output management, execution management of application software (in the present application, may be referred to as an “app” or an “application”), and the like.

The functions of the OS processing unit 120 are provided after the completion of the POST processing. That is, after the POST processing is completed, the CPU 11 executes the boot loader expanded in the main memory 12, reads out the OS module and the related software from the storage 23, and loads the OS module and the related software into the main memory 12. Thereafter, the CPU 11 starts the OS.

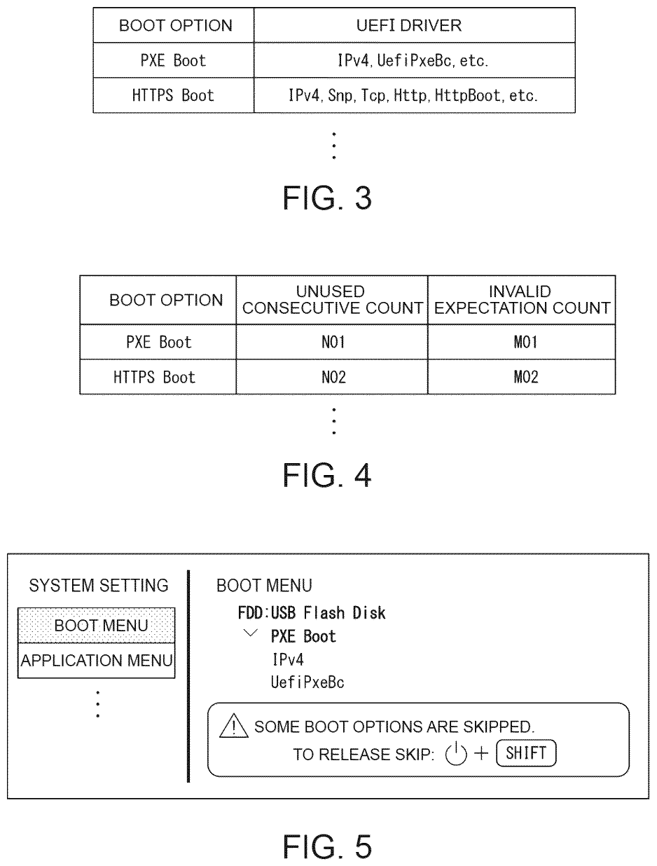

Next, a specific example of the boot option will be described. The functions related to the boot option are provided by executing one or a plurality of drivers constituting the BIOS. FIG. 3 is a table illustrating UEFI drivers corresponding to the boot options. FIG. 3 illustrates PXE Boot and HTTPS Boot as boot options. Both the PXE Boot and the HTTPS Boot are boot options related to startup processing in response to a request from another device.

A preboot execution environment boot (PXE Boot) is a function of starting up a device to be started up from another device via a communication network in accordance with a trivial file transfer protocol (TFTP). In the PXE Boot, UEFI drivers such as IPv4 and UefiPxeBc are used. TFTP is a communication protocol for performing file transfer on an Internet Protocol (IP) network. TFTP has a simple specification without functions such as retransmission control and authentication.

Hypertext transfer protocol secure boot (HTTPS Boot) is a function of starting up a device to be started up from another device in accordance with HTTPS. In HTTPS Boot, UEFI drivers such as IPv4, Snp, Tcp, Http, and HttpBoot are used. HTTPS is a communication protocol used for encrypting and transmitting data between a web server and a web client. Therefore, HTTPS Boot is accompanied by more complicated processing than the PXE Boot.

As described above, an invalid expectation count is preset for each boot option in the BIOS processing unit 110. The BIOS processing unit 110 counts the unused consecutive count of each boot option each time the POST processing is executed, and disables the boot option in which the counted unused consecutive count exceeds the invalid expectation count. The BIOS processing unit 110 sets the unused consecutive count to zero for the boot option to be executed.

FIG. 4 is a table illustrating the unused consecutive count and the invalid expectation count corresponding to the boot option. In the example of FIG. 4, for the PXE Boot, the unused consecutive count is counted as N01, and the invalid expectation count is set as M01. For the HTTPS Boot, the unused consecutive count is counted as N02, and the invalid expectation count is set as M02.

Next, an example of a setting screen according to one or more embodiments will be described. FIG. 5 is a diagram illustrating the setting screen according to one or more embodiments. The setting screen illustrated in FIG. 5 is displayed in a state where a boot menu is selected among various setting menus included in the system setting. In the example of FIG. 5, an FDD is designated as a startup disk, that is, a destination for reading a boot loader. It indicates a state in which execution of PXE Boot is instructed as a valid boot option. In addition, IPv4 and UefiPxeBc are displayed as a driver related to the PXE Boot.

The setting screen illustrated in FIG. 5 includes notification information indicating the presence of the boot option that is disabled and guide information for guiding an operation method for releasing the disablement of the boot option. A message “Some boot options are skipped” is illustrated as the notification information. As guide information, a message “To release skip” and a power button, “+”, and a shift key are illustrated in that order. As a result, the user is guided that the disabled boot option is enabled by pressing the power button and the shift key simultaneously.

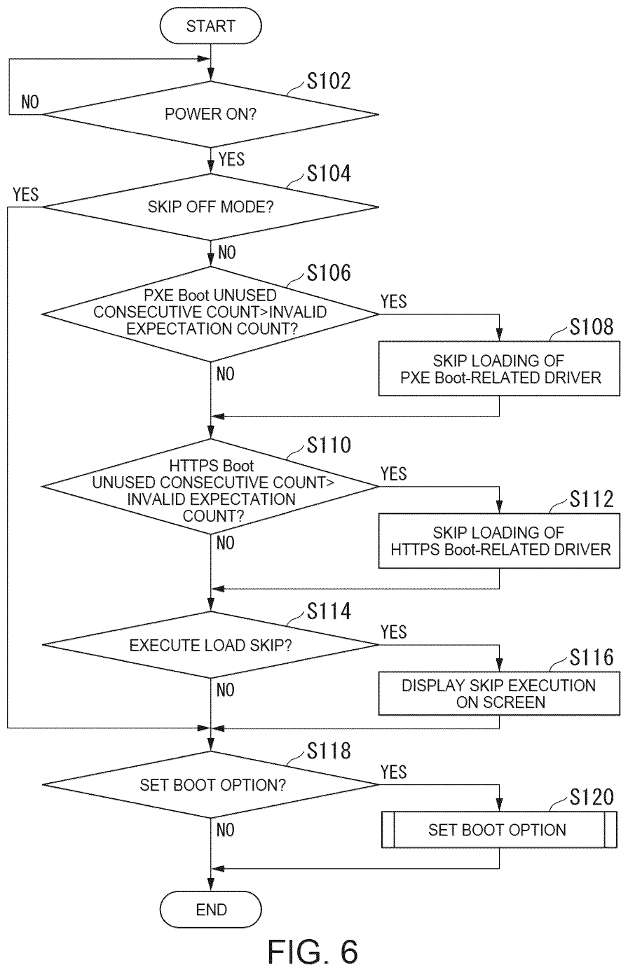

Next, an example of preboot processing according to one or more embodiments will be described. FIG. 6 is a flowchart illustrating an example of the preboot processing according to one or more embodiments. However, a case where any one of the PXE Boot, the HTTPS Boot, or other options is selectable as the boot option will be described as an example.

(Step S102) The CPU 11 waits for power on in a power-off state. When the power on is detected (YES in Step S102), the process proceeds to Step S104. When the power on is not detected (NO in Step S102), the waiting for power on is continued.

(Step S104) The CPU 11 starts reading of the BIOS from the ROM 22 and loading of the BIOS to the main memory 12, and starts the functions of the BIOS processing unit 110 in accordance with the BIOS. The BIOS processing unit 110 executes processing related to the basic device initialization and the system setting. The BIOS processing unit 110 determines whether or not a skip OFF mode is set for the boot option. When the skip OFF mode is set (YES in Step S104), the process proceeds to Step S118. When the skip OFF mode is not set (NO in Step S104), the process proceeds to Step S106.

(Step S106) The BIOS processing unit 110 compares the unused consecutive count and the invalid expectation count of the PXE Boot. When the unused consecutive count exceeds the invalid expectation count (YES in Step S106), the process proceeds to Step S108. When the unused consecutive count is equal to or less than the invalid expectation count (NO in Step S106), the process proceeds to Step S110.

(Step S108) The BIOS processing unit 110 skips the reading of the driver related to the PXE Boot and the loading of the driver into the main memory 12.

(Step S110) The BIOS processing unit 110 compares the unused consecutive count and the invalid expectation count of the HTTPS Boot. When the unused consecutive count exceeds the invalid expectation count (YES in Step S110), the process proceeds to Step S112. When the unused consecutive count is equal to or less than the invalid expectation count (NO in Step S110), the process proceeds to Step S114.

(Step S112) The BIOS processing unit 110 skips the reading of the driver related to the HTTPS Boot and the loading of the driver into the main memory 12.

(Step S114) The BIOS processing unit 110 determines whether or not the loading of the driver related to any boot option is skipped. When the loading is skipped (YES in Step S114), the process proceeds to Step S116. When the loading is not skipped (NO in Step S114), the process proceeds to Step S118. In this case, the reading of all the drivers and the loading of the drivers into the main memory 12 are performed.

(Step S116) The BIOS processing unit 110 displays the screen to indicate that the boot option is skipped. Here, the BIOS processing unit 110 regards the skipped boot option as a disabled boot option, and displays, on the display 14, notification information indicating its presence by including the notification information in the setting screen.

(Step S118) The BIOS processing unit 110 determines whether or not any boot option (for example, any of the PXE Boot, the HTTPS Boot, and the other options) is selected based on the setting information obtained in the system setting stage. When the boot option is selected (YES in Step S118), the process proceeds to Step S120. When the boot option is not selected (NO in Step S118), the process in FIG. 6 ends.

(Step S120) The BIOS processing unit 110 executes boot option setting processing (described below). At this stage, the BIOS processing unit 110 selects whether to execute the PXE Boot, the HTTPS Boot, or other options, and executes the selected boot option. Then, the process in FIG. 6 ends.

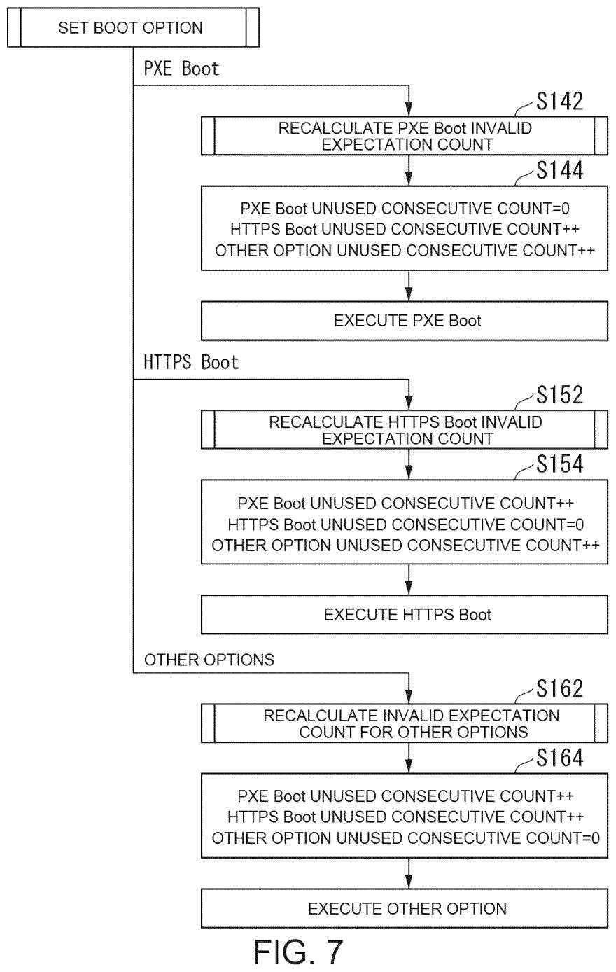

Next, an example of the boot option setting processing according to one or more embodiments will be described. FIG. 7 is a flowchart illustrating the boot option setting processing according to one or more embodiments. However, a case where the invalid expectation count for each boot option is variable instead of a constant value will be described as an example.

When the selected boot option is the PXE Boot, the HTTPS Boot, or the other option, the process proceeds to steps S142, S152, and S162, respectively.

(Step S142) The BIOS processing unit 110 executes invalid expectation count recalculation processing (described later) for the PXE Boot.

(Step S144) The BIOS processing unit 110 resets the unused consecutive count of the PXE Boot to zero, increments the unused consecutive count of the HTTPS Boot by one, and increments the unused consecutive count of the other options by one. Then, the process in FIG. 7 ends. In the POST processing, the BIOS processing unit 110 executes processing related to the PXE Boot and does not execute processing related to the HTTPS Boot and other options.

(Step S152) The BIOS processing unit 110 executes invalid expectation count recalculation processing for the HTTPS Boot.

(Step S154) The BIOS processing unit 110 resets the unused consecutive count of the HTTPS Boot to zero, increments the unused consecutive count of the PXE Boot by one, and increments the unused consecutive count of other options by one. Then, the process in FIG. 7 ends. The BIOS processing unit 110 executes processing related to the HTTPS Boot and does not execute processing related to the PXE Boot and other options in the POST processing.

(Step S162) The BIOS processing unit 110 executes invalid expectation count recalculation processing for the other options.

(Step S164) The BIOS processing unit 110 resets the unused consecutive count of the other options to zero, increments the unused consecutive count of the PXE Boot by one, and increments the unused consecutive count of the HTTPS Boot by one. Then, the process in FIG. 7 ends. The BIOS processing unit 110 executes processing related to the other options in the POST processing, and does not execute processing related to the PXE Boot and the HTTPS Boot.

The invalid expectation counts of the PXE Boot, the HTTPS Boot, and the other options may be a predetermined constant value. When the selected boot option is the PXE Boot, the HTTPS Boot, or the other option, the processes of steps S142, S152, and S162, respectively, are omitted, and the process proceeds to steps S144, S154, and S164.

The BIOS processing unit 110 may update the invalid expectation count such that the greater the difference between the unused consecutive count and the invalid expectation count for the boot option, the smaller the invalid expectation count becomes. However, the BIOS processing unit 110 reduces the invalid expectation count by an amount smaller than the difference between the unused consecutive count and the invalid expectation count. As a result, the invalid expectation count is determined according to the usage situation while suppressing the rapid fluctuation. However, when the invalid expectation count calculated based on the difference exceeds a predetermined upper limit, the BIOS processing unit 110 determines the upper limit as the corrected invalid expectation count. When the invalid expectation count determined based on the difference falls below a predetermined lower limit, the BIOS processing unit 110 determines the lower limit as the corrected invalid expectation count.

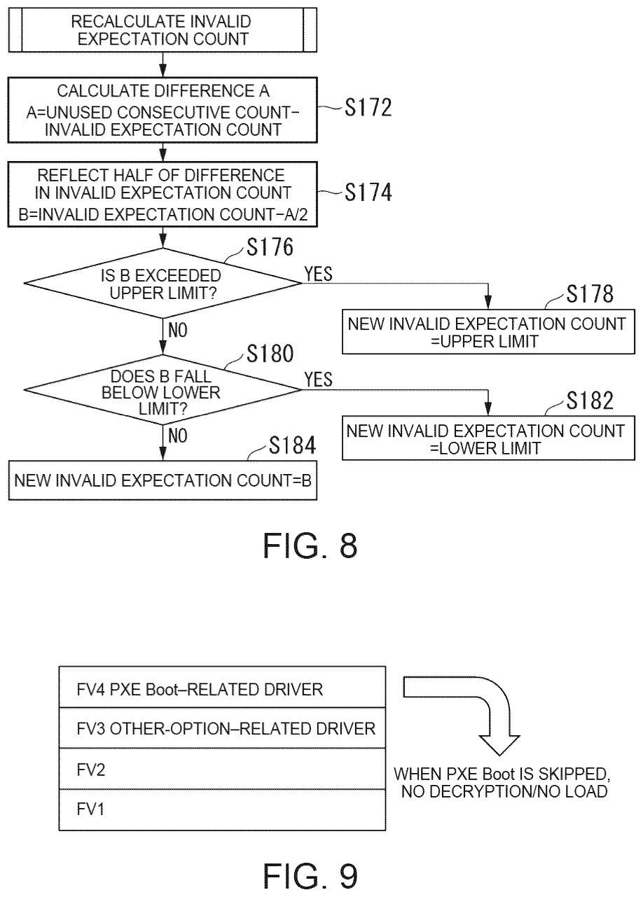

Next, an example of the invalid expectation count recalculation processing according to one or more embodiments will be described. FIG. 8 is a flowchart illustrating the invalid expectation count recalculation processing according to one or more embodiments.

(Step S172) The BIOS processing unit 110 calculates a difference A obtained by subtracting the invalid expectation count from the unused consecutive count at that time for the corresponding boot option.

(Step S174) The BIOS processing unit 110 calculates a value B by subtracting half of the difference A from the invalid expectation count at that time. When a fractional part occurs below the decimal point in the value B, the BIOS processing unit 110 rounds the value B.

(Step S176) The BIOS processing unit 110 determines whether or not the value B exceeds the predetermined upper limit. When the upper limit is exceeded (YES in Step S176), the process proceeds to Step S178. When the upper limit is not exceeded (NO in Step S176), the process proceeds to Step S180.

(Step S178) The BIOS processing unit 110 sets the upper limit as the invalid expectation count. Then, the process in FIG. 8 ends.

(Step S180) The BIOS processing unit 110 determines whether or not the value B falls below the predetermined lower limit. When the value B falls below the lower limit (YES in Step S180), the process proceeds to Step S182. When the value B does not fall below the lower limit (NO in Step S180), the process proceeds to Step S184.

(Step S182) The BIOS processing unit 110 sets the lower limit as the invalid expectation count. Then, the process in FIG. 8 ends.

(Step S184) The BIOS processing unit 110 determines the value B as a new invalid expectation count. Then, the process in FIG. 8 ends.

Here, an example of calculating the corrected invalid expectation count will be described. However, it is assumed that the lower limit and the upper limit of the invalid expectation count are 2 and 50, respectively. When the invalid expectation count at that time (present) is 10 and the unused consecutive count is 20, the corrected invalid expectation count is 5.

When the invalid expectation count is 20 and the unused consecutive count is 10 at that time, the corrected invalid expectation count is 25.

When the invalid expectation count is 2 and the unused consecutive count is 50 at that time, the corrected invalid expectation count is 2.

When the invalid expectation count is 6 and the unused consecutive count is 5 at that time, the corrected invalid expectation count is 6.

In the ROM 22, as described above, the individual drivers are stored in a distributed manner in any of the plurality of FVs. A plurality of drivers may be stored in the FV corresponding to each function type. In addition, the stored drivers may be encrypted on an FV basis. In that case, the BIOS processing unit 110 decrypts the entire encrypted driver stored in the FV in which the target driver is stored before loading the target driver to be processed into the main memory 12 in the POST processing, and extracts the target driver from the entire plaintext driver obtained by decryption and loads the target driver into the main memory 12. Therefore, the decryption processing for the driver whose execution is omitted is unnecessary.

Therefore, the BIOS processing unit 110 may set, in advance, driver information indicating a driver related to each function including the boot option and an FV of a storage destination. The BIOS processing unit 110 refers to the driver information and specifies the FV in which the driver related to the boot option whose execution is omitted is stored. The BIOS processing unit 110 determines whether or not the specified FV stores a driver related to another function to be executed without omission. In the POST processing, the BIOS processing unit 110 omits decrypting the drivers stored in the specified FV that does not store a driver related to the other functions to be executed. Accordingly, the time required to reach the boot processing is further shortened.

In the example of FIG. 9, four FV1 to FV4 are set in the ROM 22. Among them, the encrypted PXE Boot-related driver or the encrypted HTTPS Boot-related driver is stored in the FV4 as the network-based FV, and the encrypted other option-related driver is stored in the FV3. Here, when the execution of the PXE Boot and the HTTPS Boot is skipped and the other option is selected as the execution target, the BIOS processing unit 110 omits decrypting the drivers stored in the FV4 in the POST processing. As a result, the loading into the main memory 12 is omitted. On the other hand, the BIOS processing unit 110 reads out the encrypted drivers stored in the FV3 and executes decryption. The BIOS processing unit 110 loads the plaintext driver obtained after the decryption into the main memory 12.

In the above description, an application example to the boot option has mainly been described as the selectable function, but the present invention is not limited thereto. One or more embodiments may be applied to selectable functions other than the boot options (for example, BIOS setup, BIOS flash, and the like), either in place of the boot options or together with the boot options. Here, the BIOS setup refers to setting items (for example, a startup disk, an input device such as a keyboard, a language, and the like) presented by a setup menu which is a setting screen separate from the boot option. The BIOS flash refers to updating the drivers related to the BIOS stored in the ROM 22.

The electronic apparatus 1 is not necessarily limited to the laptop PC, and may be an electronic apparatus implemented in other forms, such as a desktop PC and a tablet terminal device.

In addition, as the operation method for releasing the disablement of the selectable function, the simultaneous pressing of the power button and the shift key has been exemplified, but the present invention is not limited to this. For example, the present invention may be applied to a pressing operation for another key instead of the shift key. In addition, releasing the disablement may be set as a part of the boot mode setting items. In addition, when startup is performed in response to detecting the approach or operation of a predetermined specific user by a known method, releasing the disablement may be executed.

As described above, the electronic apparatus 1 according to one or more embodiments includes the host system 10, and the host system 10 executes the initialization processing (for example, the POST processing) in accordance with the firmware (for example, the BIOS) before the startup of the operating system. The initialization processing has a selectable function (for example, the boot option) that is a function in which whether or not to execute is selectable, and each time the initialization processing is executed, disablement of the selectable function is determined based on an unused consecutive count, which is the number of times the selectable function is not executed consecutively.

According to this configuration, the disablement of the selectable function in which whether or not to execute is selectable based on the unused consecutive count that is not consecutively executed is determined. Processing for the selectable function that is not used is omitted. For this reason, the time required for the initialization processing is shortened.

In addition, the host system 10 may display a notification screen representing the disablement on the display 14 when the selectable function is disabled.

With this configuration, the notification screen representing the disablement of the selectable function is displayed on the display 14. Accordingly, the user who encounters the notification screen is notified of the disablement of the selectable function.

In addition, the notification screen may represent an operation method for releasing the disablement of the selectable function. With this configuration, the operation method for releasing the disablement of the selectable function is displayed on the display 14. Therefore, a user who encounters the notification screen is given a clue for releasing the disablement of the selectable function.

In addition, the host system 10 may decrease an invalid expectation count, which is a reference value for determining the disablement by comparison with the unused consecutive count, the invalid expectation count decreasing as a difference between the unused consecutive count and the invalid expectation count increases.

With this configuration, the greater the difference between the unused consecutive count and the invalid expectation count, the more the invalid expectation count decreases. When the unused consecutive count does not reach the invalid expectation count, the invalid expectation count is corrected so that the difference from the unused consecutive count becomes smaller. Therefore, the invalid expectation count is corrected according to the execution status of the selectable function.

In addition, the electronic apparatus 1 may have a plurality of storage regions (for example, FVs) and may include a storage medium (for example, the ROM 22) in which encrypted drivers are stored for the respective storage regions. The host system 10 may specify a storage region in which a driver corresponding to a function that is not executed is stored and a driver corresponding to a function that is executed is not stored, and omit decryption of the driver stored in the storage region.

With this configuration, the decryption of the driver corresponding to the selectable function that is not executed is omitted. By omitting the decryption of the driver, the time required for the initialization processing is shortened.

The selectable function may be a function related to startup of an operating system instructed from another apparatus (for example, PXE Boot, HTTPS Boot).

Although embodiments of the present application has been described in detail with reference to the drawings, the specific configuration is not limited to the above-described embodiment, and designs and the like within a range not departing from the gist of the present invention are also included. Each configuration described in the above-described embodiment can be combined in any manner.

### DESCRIPTION OF SYMBOLS

1 electronic apparatus
10 host system
11 CPU
12 main memory
13 video subsystem
14 display
21 chipset
22 ROM
23 storage
25 WLAN module
26 input/output I/F
31 EC
32 input device
34 power supply circuit
38 power button
110 BIOS processing unit
120 OS processing unit

What is claimed is:

1. An electronic apparatus comprising:
a host system,
wherein the host system executes initialization processing in accordance with firmware before startup of an operating system,
the initialization processing has a selectable function, the selectable function being a function which whether or not to execute is selectable, and
each time the initialization processing is executed, the host system determines disablement of the selectable function based on an unused consecutive count, the unused consecutive count being a number of times the selectable function is not executed consecutively.

2. The electronic apparatus according to claim 1,
wherein the host system causes a display to display a notification screen representing the disablement when the host system disables the selectable function.

3. The electronic apparatus according to claim 2,
wherein the notification screen represents an operation method for releasing the disablement.

4. The electronic apparatus according to claim 1,
wherein the host system decreases an invalid expectation count as a difference between the unused consecutive count and the invalid expectation count increases, the invalid expectation count being a reference value for determining the disablement by comparison with the unused consecutive count.

5. The electronic apparatus according to claim 1, further comprising:
a storage medium including a plurality of storage regions, each of the plurality of storage regions where an encrypted driver is stored,
wherein the host system
specifies a storage region in which a driver corresponding to a function that is not executed is stored and a driver corresponding to a function that is executed is not stored, and
omits decryption of the driver stored in the storage region.

6. The electronic apparatus according to claim 1,
wherein the selectable function relates to startup of an operating system instructed from another apparatus.

7. A control method for an electronic apparatus including a host system,
wherein the host system executes initialization processing in accordance with firmware before startup of an operating system,
the initialization processing has a selectable function, the selectable function being a function which whether or not to execute is selectable, and
each time the initialization processing is executed, the host system determines disablement of the selectable function based on an unused consecutive count, the unused consecutive count being a number of times the selectable function is not executed consecutively.
